(19) United States
(12) Patent Application Publication
(10) Pub. No.: US 2004/0023562 A1
(43) Pub. Date: Feb. 5, 2004

(54) Contact pin for socket

(75) Inventors: John Brett Barry, Downers Grove, IL (US); Michael G. Amaro, Naperville, IL (US); Mark Daniel Fleszewski, Midlothian, IL (US); Jeffrey T. Bellandi, Warrenville, IL (US)

Correspondence Address: TEXAS INSTRUMENTS INCORPORATED, P O BOX 655474, M/S 3999, DALLAS, TX, 75265

(73) Assignee: Texas Instruments Incorporated, Dallas, TX

(21) Appl. No.: 10/208,077

(22) Filed: Jul. 30, 2002

(51) Int. Cl. H01R 24/00

(52) U.S. Cl. 439/660

(57) ABSTRACT

A contact for a pin receiving socket includes, in order, a top flange, an angled pin guiding portion, a first contact point, a recess, a second contact point, a flex shaft, an anchor portion, and an external connection portion. The contact, and preferably two identical contacts, is mounted in a pin receiving opening of a socket body. The anchor portion is secured in the socket body at the bottom of the pin receiving opening, and the external connection portion extends through and out of the socket body. When a pin is inserted, the first contact point rubs or wipes any debris or contaminants from the pin and the second contact point makes and electrical connection to the cleaned part of the pin.

### BACKGROUND OF THE INVENTION

1. Field of the Invention

The present invention relates generally to a socket for receiving connector pins and, in particular, to contact pin for such socket.

2. Description of the Related Art

Electronic components, sub-assemblies and assemblies generally are electrically connected via pins that extend from the unit or by contact surfaces, such as on an edge of a circuit board. These pins or contact surfaces may be received between contacts to effect the electrical connection. The pins can be subject to oxidation, or may have an accumulation of debris or residue such as solder flux, oils etc., resulting in a less than ideal electrical connection with the pins or contact surfaces. For assemblies and sub-assemblies, such as daughter boards, power controllers and the like, the assemblies and sub-assemblies are subjected to soldering processes and other manufacturing steps which may leave residue on the pins. This residue interferes with a good electrical connection to the pins.

The electronic assemblies and sub-assemblies may require testing prior to final assembly and/or shipping. Such testing is accomplished by electrically connecting test equipment to the pins of the assembly or sub-assembly, for example, by plugging into a socket. Such testing is particularly susceptible to debris and residue on the pins, since the assemblies and sub-assemblies have in most instances not been used and have generally only recently been manufactured.

The poor electrical contact with the pins which results from debris and residue on the pins gives inaccurate test results during the testing of the assemblies or sub-assemblies. Retesting of the devices is required. The poor electrical contact may even result in the perfectly operating electrical devices being identified as faulty.

### SUMMARY OF THE INVENTION

The present invention provides an electrical contact which ensures good electrical connection to pins of a device, assembly or sub-assembly that has been plugged thereinto. The electrical connection is ensured by a double wiping contact which contacts the pins of the device, assembly or sub-assembly at two locations as the pins are inserted into a connection socket. The first contact point wipes away any oxides, debris or residue from the contact surface of the pin, and the second contact point makes the electrical connection.

In a preferred form, two such double wiping contacts are provided opposite one another and the pins or contact surfaces are inserted therebetween.

### BRIEF DESCRIPTION OF THE DRAWINGS

FIG. 1 is a perspective view of sockets for connection to connector pins of a device, assembly or sub-assembly according to the principles of the present invention;

FIG. 2 is a bottom perspective view of the socket assembly as shown in FIG. 1;

FIG. 3 is a sectional view through a unit of the socket assembly, showing two contacts mounted therein;

FIG. 4 is a side elevational view of a contact for mounting in the socket assembly; and

FIG. 5 is a front elevational view of the contact of FIG. 4; and

FIG. 6 is a cross section showing a contact pin of a device, assembly or sub-assembly received between the contacts of the present invention.

### DETAILED DESCRIPTION OF THE PREFERRED EMBODIMENTS

Referring first to FIG. 1, a socket assembly 10 is shown, including a work surface 12 in which the socket assembly is mounted. The socket assembly is formed of a plurality of socket bodies 14 joined to one another and mounted with a top surface 16 flush with the work surface. The socket bodies 14 are connected end-to-end to form a line of pin receiving openings 18 for contact pins of a device, assembly or sub-assembly. The socket assembly 10 is preferably configured to have a number of the pin receiving openings 18 which corresponds to the number of contact pins on the device, assembly or sub-assembly to be plugged thereinto. Of course, it is also possible that the socket assembly 10 may have more pin receiving openings 18 than there are pins on the device, assembly or sub-assembly.

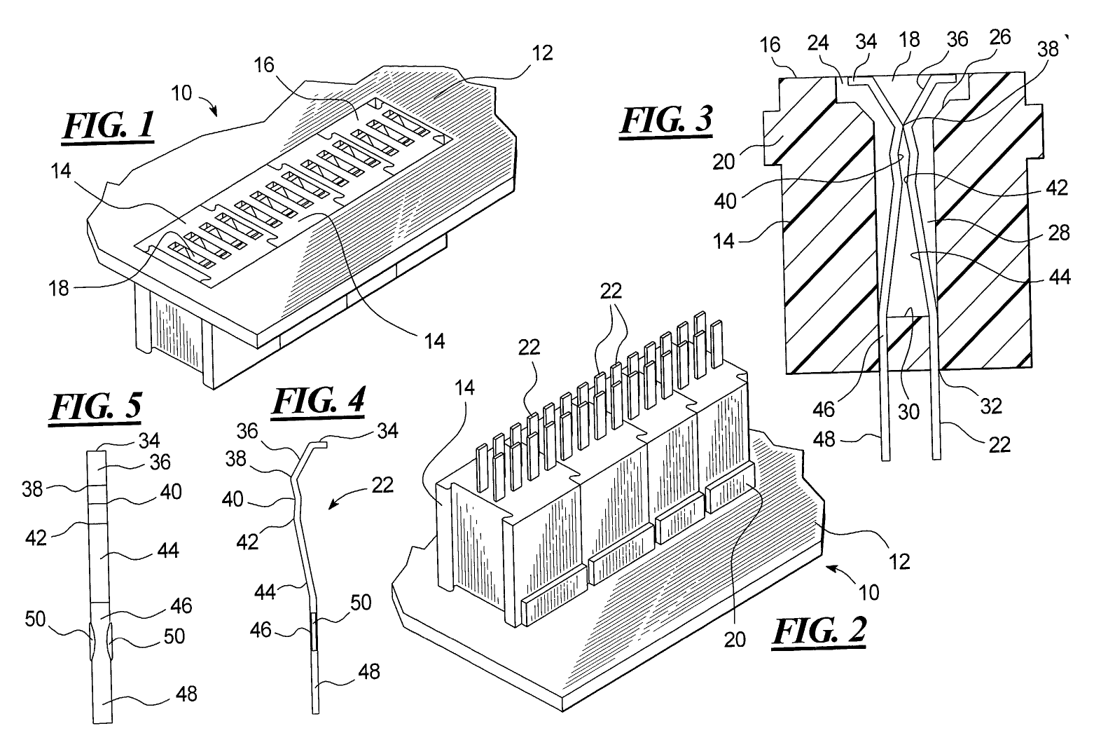

FIG. 2 shows the socket assembly 10 in a bottom view, including the underside of the work surface 12 resting on ledges 20 on the socket bodies 14. The socket bodies 14 have contacts 22 with ends that extend from the underside of the socket bodies 14 to which electrical connections are made.

In FIG. 3, the socket body 14 has a rectangular configuration with a central opening 18 in which a pair of contacts 22 mounted. The opening 18 in the socket body 14 has an enlarged upper portion 24, a beveled transition region 26, and an extended lower portion 28. The opening 18 ends at a bottom 30 before the lower surface of the socket body 14 so that the opening is closed at its lower end, except for contact passages 32 which extend through the closed lower end 30 of the opening18. The contacts 22 are mounted in the central opening 18 and anchored in the contact passages32. The ledges 20 on which the work surface 12 rests are shown.

The contacts 22 are mounted in the central opening 18 of the socket body 14 in pairs, facing one another. Each contact 22 has a top flange 34, a pin guide portion 36 at an angle, a first contact point 38, a recessed portion 40, a second contact point 42, a flex shaft 44, an anchor portion 46, and an external contact portion 48. The top flange 34 is substantially flush with the top surface 16 of the socket body. The pin guide 36 is angled to guide a contact pin between the two contacts22, and in one embodiment is approximately at a 28 degree angle from vertical, although other angles would of course work, for example in a range of 10 degrees to 60 degrees.

The first contact point 38 of the contact 22 is pressed against the first contact point 38 of its mate. The recessed portion 40 provides a clearance between the contact pair 22, and the second contact point 42 is pressed against the second contact point, or very nearly in contact with the second contact point 42, of the mating contact. The flex shaft 44 flexes to permit the contact points 38 and 42 to be pushed apart to accept a contact pin.

The anchor portion 46 is held in the socket body 14 at the end 30 of the opening 18 so that the flex portion 44 flexes relative to the anchor portion 46. The contact 22 is prevented from axial movement by the anchor portion 46, as well. The external connection portion 48 may be soldered, wire wrapped or otherwise connected to external circuitry.

An individual contact 22 is shown in FIG. 4. The contact 22 has been formed to the shape as shown to define the various portions discussed above. The contact 22 is of a metal or metal alloy having good electrical conducting properties and the ability to flex to accept the contact pins.

In a preferred embodiment, the contact is of beryllium copper alloy 172 and is provided with a gold coating deposited by a plating process.

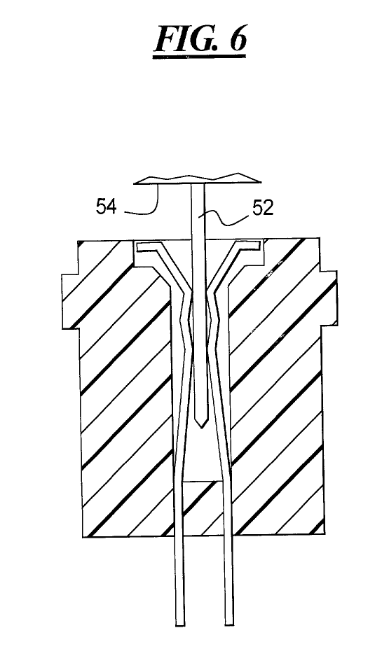

Referring to FIG. 5, the contact is of a width that is greater than its thickness, so as to permit flexing. The width is comparable to the width of the opening in the socket body. In the view of FIG. 5 can be seen pinched portions 50 at the anchor portion 46 of the contact 22. The pinched portions 50 are formed by stamping the metal contact body to slightly flatten the metal in one direction while expanding in another. The pinched portions 50 permit the plastic socket body 14 to securely hold the contact 22 in place.

The contact pin 52 of a device, assembly or sub-assembly 54 has been inserted into the socket 14, as shown in FIG. 6. The contact pin 52 is in electrical contact with the contact member 22 at two locations, namely at the first contact point 38 and at the second contact point 42. To reach the position shown in FIG. 6, the pin 52 has been pushed into the opening 18 where it is guided in by the angled portion 36 to between that contact pair at the first contact points 38. The first contact points 38 rub against the pin 52 as the pin 52 is pushed in further to reach the second contact points 42.

The rubbing motion of the first contact points 38 removes, or at least substantially reduces, any debris or residue on the pin 52 which would otherwise interfere with the electrical connection. Such debris could be flux or other cleaner from a soldering operation, oil from a stamping operation, resin from a resin filling operation, oxidation, etc. The removal or reduction of the debris from the pin 52 by the first contact point 38 means that the second contact point 42 presses against a part of the pin 52 that has been rubbed clean (or at least cleaner). The second contact points 42 of the contact pair make a clean contact with the pin 52. The present contact thus provides a built-in wiping function.

The present contact arrangement finds particular utility as a connector for test operations where devices, assemblies or sub-assemblies are plugged in temporarily for testing the performance of the unit. The contact is thus in contact with the pin for a limited time, and not used for a long duration contact. A test bench or a burn-in facility for circuits is a primary area of use for the present contact. Such temporary contact situations are more likely to involve contaminants and debris on the pins. A device under test may have foreign material on the surface of the pin and the present contact has proven effective in removing the foreign material. More accurate testing and reduced need for retesting of the devices under test is necessary when using the present contact.

Examples of devices, assemblies or sub-assemblies on which the present contact may be used include power supply units, DIP (Dual In-line Pin) components, SIP (Single In-line Pin) components, ICs (Integrated Circuits), and electrical modules.

It is within the scope of the present invention that the contacts are provided in a socket configuration other than the one illustrated. For example, the socket need not be formed from a plurality of socket bodies, but may be of one piece. It is foreseen that a single contact may be provided instead of the two contacts of the pair as shown. In this case, the single contact may press the pin against a surface, be it conducting or non-conducting. The present contact may also be used with a second contact of a different shape, rather that two identical oppositely mounted contacts as shown.

The present contact may have a shape varying from that illustrated, the significant feature being the two contact points which permit a pin or other contact element to be rubbed clean as it is inserted to provide a clean contact by the second contact point.

The present contact may be used with plated contact surfaces on a circuit board or other element, and is not limited to use with pin contacts.

Although other modifications and changes may be suggested by those skilled in the art, it is the intention of the inventors to embody within the patent warranted hereon all changes and modifications as reasonably and properly come within the scope of their contribution to the art.

We claim:

1. A contact for electrical connection to a pin or contact surface, comprising:
an elongated body of conductive material having first and second ends;
an angled portion of said elongated body adjacent said first end;
a first contact point of said elongated body adjacent said angled portion;
a second contact point of said elongated body spaced from said first contact point; and
an anchor of said elongated body adjacent said second end.

2. A contact as claimed in claim 1, further comprising:
a flange at said first end of said elongated body between said angled portion and said first end, said flange being substantially perpendicular to an overall extent of said elongated body.

3. A contact as claimed in claim 1, further comprising:
an external contact part at said second end of said elongated body between said second end and said anchor.

4. A contact as claimed in claim 1, further comprising:
a recessed part between said first contact point and said second contact point.

5. A contact socket for receiving a pin or contact surface, comprising:
a socket body of a non-conductive material, said socket body defining a pin receiving opening, said pin receiving opening having a bottom;
at least one contact in said pin receiving opening, said at least one contact having first and second ends;
an angled portion of said at least one contact adjacent said first end;
a first contact point of said at least one contact adjacent said angled portion;
a second contact point of at least one contact spaced from said first contact point along a length of said at least one contact;
a flex shaft adjacent said second contact along a length of said at least one contact;
an anchor portion of said at least one contact secured in said socket body at said bottom of said pin receiving opening; and
an external contact portion of said at least one contact extending from said socket body.

6. A contact socket as claimed in claim 5, wherein said at least one contact is a first contact and further comprising:
a second contact mounted in said pin receiving opening.

7. A contact socket as claimed in claim 6, wherein said first and second contacts are substantially identical and mounted in mirror image relative to one another.

8. A contact socket for receiving a pin or contact surface, comprising:
a socket body of a non-conductive material, said socket body defining a pin receiving opening, said pin receiving opening having a bottom;
two contacts in said pin receiving opening of said socket body, said two contacts being mounted in mirror orientation to one another, each of said two contacts having:
first and second ends;
an angled portion adjacent said first end disposed to direct the pin or contact surface to between said two contacts;
a first contact point adjacent said angled portion for contact with a contact portion of the pin or contact surface when the pin or contact surface as the pin or contact surface is moved to between said two contacts;
a second contact point spaced from said first contact point along a length of said two contacts to contact the contact portion of the pin or contact surface when the pin or contact surface is disposed between said two contacts, said second contact point contacting the contact portion of the pin or contact surface at a portion contacted by said first contact point during movement of the pin or contact surface to between said second contact point;
a flex shaft adjacent said second contact along a length of said two contacts;
an anchor portion of said two contacts secured in said socket body at said bottom of said pin receiving opening; and
an external contact portion of said two contacts extending from said socket body.

9. A method of electrically contacting a pin or contact surface, comprising the steps of:
providing a socket having a pair of contacts to receive the pin or contact surface therebetween;
receiving the pin or contact surface between the pair of contacts at first contact points;
rubbing any debris or residue on the pin or contact surface from a contact portion of the pin or contact surface as the pin or contact surface is moved between the first contact points; and
contacting the pin or contact surface at said contact portion with second contact points.

10. A method for electrically contacting a pin or contact surface for testing, comprising the steps of:
providing a testing socket having a pair of contacts to receive the pin or contact surface therebetween;
receiving the pin or contact surface between the pair of contacts at first contact points;
rubbing any debris or residue on the pin or contact surface from a contact portion of the pin or contact surface as the pin or contact surface is moved between the first contact points; and
contacting the pin or contact surface at said contact portion with second contact points for testing.
